(19) United States
(12) Patent Application Publication
(10) Pub. No.: US 2025/0212886 A1
(43) Pub. Date: Jul. 3, 2025

(54) COMPOSITIONS AND METHODS FOR CONTROLLING INSECTS

(71) Applicant: SYNGENTA CROP PROTECTION AG, Basel (CH)

(72) Inventor: Roderick Justin BURKE, Fulbourn, Cambridge (GB)

(73) Assignee: SYNGENTA CROP PROTECTION AG, Basel (CH)

(21) Appl. No.: 18/849,295

(22) PCT Filed: Mar. 23, 2023
(86) PCT No.: PCT/EP2023/057558

§ 371 Date: Sep. 20, 2024

(30) Foreign Application Priority Data
Mar. 23, 2022 (EP) 22163755.6

(51) Int. Cl. A01N 63/12; A01N 43/40; A01P 7/04

(52) U.S. Cl. CPC A01N 63/12; A01N 43/40; A01P 7/04

(57) ABSTRACT

The present invention provides a method and composition for controlling a Tipula spp. insect larvae pest at a turfgrass locus by using a combination of chlorantraniliprole and entomopathogenic nematodes.

This invention concerns a method for controlling insect pests. In particular, the invention relates to a method of controlling Tipula spp. insect pest by application of chlorantraniliprole and entomopathogenic nematodes to the insect pest, to a locus of the insect pest, or to a turfgrass susceptible to attack by the insect pest. The invention also encompasses compositions comprising chlorantraniliprole and entomopathogenic nematodes, for controlling Tipula spp. insect pests, in particular in turfgrass.

The need for control of insect pests is a constantly recurring problem in amenity turf as well as in other landscaped turf areas. Lawns often include a variety of insects, some of which are direct pests of grass, or nuisances and pests to humans and pets. The control of the larval stages of turf insect pests can be a particular challenge. For example, adult flies of T. paludosa mate and lay eggs in turfgrass below the soil surface. The first instars hatch in and develop through four instars in soil, feeding through the winter until they enter a resting phase before pupation to craneflies. Leatherjackets are larvae of the cranefly (Tipula spp.) and they can do immense damage to grasslands, lawns and occasionally also to small plants. Burrowing under the ground, they eat roots and produce bare and yellowing patches of turfgrass.

To help combat and manage these insect problems, researchers in the field of synthetic chemistry have produced an extensive variety of chemicals and chemical formulations effective in the control of such unwanted growth. Chemical insecticides of many types have been disclosed in the literature and a large number are in commercial use. Commercial insecticides and some that are still in development are described, for example, in ‘The Pesticide Manual’, 19th Edition, published 2021 by the British Crop Protection Council. Chlorantraniliprole is an insecticide that is useful against turf insect pests.

The activity of insecticides can be enhanced in various ways to achieve the maximum benefit. One of the ways to enhance insecticidal efficacy is to use combinations. However, identifying the appropriate active ingredient combinations and application rates to achieve extended insect control with reduced environmental loading is not straight forward.

Biopesticides are a natural alternative to chemical insecticides for the control of insect pests. For example, entomopathogenic nematodes are comparatively safe, and are generally non-toxic to users and consumers, decompose rapidly and can be targeted at specific pests to avoid harming beneficial insects. However, biopesticides sometimes face technological barriers such as poor shelf-life, for example, that may reduce adaptability.

Use of entomopathogenic nematodes for turf, sport and amenity applications to control insects have previously been described in the literature, for example, in WO2020053603.

Combinations of chlorantraniliprole and the entomopathogenic nematode Heterorhabditis bacteriophora for control of third-instar white grubs in turfgrass have been reported. (Koppenhöfer et al. Biological Control 45 (2008)).

There remains a need for improved Tipula spp. insect control methods in turf, sport and amenity applications, in particular, integrated pest management methods for controlling insect larvae of Tipula spp. in turf.

In accordance with the present invention, it has now been discovered that the effectiveness of chlorantraniliprole in the control of Tipula spp. insect larvae in turf is enhanced when it is co-applied with entomopathogenic nematodes.

Accordingly, the present invention provides a method of controlling or managing Tipula spp. insect larvae pests in turf by using a combination of chlorantraniliprole and entomopathogenic nematodes comprising a) applying an effective amount of chlorantraniliprole to the turfgrass and b) applying an effective amount of entomopathogenic nematodes to the turfgrass.

In particular, the present invention may be used to control insect pests that feed on the roots and above-ground plant parts of turfgrass including leatherjackets (European crane fly, Tipula paludosa).

In one embodiment, the entomopathogenic nematodes are applied at a reduced rate relative to the normal application rate of infective juvenile (IJ) entomopathogenic nematodes that are required to control such Tipula spp. larvae at a locus by a solo application (including one time or split dose application).

The terms “reduced rate” may refer to a rate of application that is 30 to 80%, preferably 45 to 75%, more preferably 50 to 60% and most preferably at least 50% or half-rate when compared to the full rate of application of entomopathogenic nematodes (including one time or split dose application) that are typically applied or indicated on a product label for control of Tipula spp. populations esp. larvae.

The present invention can be practiced with all turfgrasses, including cool season turfgrass and warm season turfgrass.

Examples of cool season turfgrasses are: Bluegrasses (Poa L.), such as Kentucky Bluegrass (Poa pratensis L.), Rough Bluegrass (Poa trivialis L.), Canada Bluegrass (Poa compressa L.) and Annual Bluegrass (Poa annua L.); Bentgrasses (Agrostis L.), such as Creeping Bentgrass (Agrostis palustris Huds.), Colonial Bentgrass (Agrostis tenius Sibth.), Velvet Bentgrass (Agrostis canina L.) and Redtop (Agrostis alba L.); Fescues (Festuca L.), such as Creeping Red Fescue (Festuca rubra L.), Chewings Fescue (Festuca rubra var. commutata Gaud.), Sheep Fescue (Festuca ovina L.), Hard Fescue (Festuca longifolia), Tall Fescue (Festuca arundinacea Schreb.), Meadow Fescue (Festuca elatior L.); Ryegrasses (Lolium L.), such as Perennial Ryegrass (Lolium perenne L.), Annual (Italian) Ryegrass (Lolium multiflorum Lam.); Wheatgrasses (Agropyron Gaertn.), such as Fairway Wheatgrass (Agropyron cristatum (L.) Gaertn.), Western Wheatgrass (Agropyron smithii Rydb.). Other cool season turfgrasses include Smooth Brome (Bromus inermis Leyss.) and Timothy (Phleum L.).

Examples of warm season turfgrasses are Bermudagrasses (Cynodon L. C. Rich), Zoysiagrasses (Zoysia Willd.), St. Augustinegrass (Stenotaphrum secundatum (Walt.) Kuntze), Centipedegrass (Eremochloa ophiuroides (Munro.) Hack.), Carpetgrass (Axonopus Beauv.), Bahiagrass (Paspalum notatum Flugge.), Kikuyugrass (Pennisetum clandestinum Hochst. ex Chiov.), Buffalograss (Buchloe dactyloides (Nutt.) Engelm.) and Seashore paspalum (Paspalum vaginatum swartz).

More specifically, the present invention provides a method for controlling Tipula spp. insect larvae in turf which comprises applying an effective Tipula spp. insect larvae pest controlling amount of chlorantraniliprole to the locus of the pest, followed by an application of from 30 to 80%, preferably 50 to 75% of an effective Tipula spp. insect larvae pest controlling amount of entomopathogenic nematodes to said locus.

Embodiments according to the method of the invention are provided as set out below.

In one embodiment, the present invention provides a method for controlling Tipula spp. insect larvae in turf which comprises sequentially applying an effective Tipula spp. insect larvae pest controlling amount of chlorantraniliprole to the locus of the pest, followed by an application of from 30 to 80% (preferably 50 to 75%) of an effective Tipula spp. insect larvae pest controlling amount of entomopathogenic nematodes to said locus.

In one embodiment, the chlorantraniliprole is applied to the locus of the Tipula spp. insect larvae pest at a rate of 75-300 g/ha, preferably 100-300 g/ha. In a preferred embodiment, the chlorantraniliprole is applied to said locus at a rate of 120 g/ha. In another preferred embodiment, 0.61 of a suspension concentrate formulation containing 200 g/l chlorantraniliprole is applied to said locus in an aqueous spray composition comprising 500-1000 l/ha water; preferably 800l/ha water.

In another embodiment, the Tipula spp. insect larvae pest to be controlled is Tipula paludosa or Tipula oleracea. In a further embodiment, Tipula spp. insect larvae pest is in the 1^{st}, 2^{nd}, 3^{rd} or 4^{th} instar stages. In another embodiment, the Tipula spp. insect larvae pest is a leatherjacket.

In one embodiment, the entomopathogenic nematode used in the method is selected from the Heterorhabditis genera and/or the Steinernema genera. Preferably the entomopathogenic nematode is selected from the group: Heterorhabditis bacteriophora, Heterorhabditis downesi, Steinernema feltiae, Steinernema carpocapsae, and/or Steinernema kraussei. In a preferred embodiment, the entomopathogenic nematode comprises S. carpocapsae and/or S. feltiae. Most preferably, the entomopathogenic nematode comprises Steinernema feltiae.

At a turf pest locus, when a full rate of application of entomopathogenic nematodes as a solo is, for example, 7.5 billion IJ/ha, said reduced rate of application may refer to an application rate that is 30 to 80%, preferably 45 to 75%, more preferably 50 to 60% of such rate such as from 2.5 billion IJ/ha to 5 billion IJ/ha. At a turf pest locus, when a full rate of application of entomopathogenic nematodes as a solo is, for example, 5 billion IJ/ha, said reduced rate of application may refer to an application rate that is 30 to 80%, preferably 45 to 75%, more preferably 50 to 60% of such rate such as from 2.5 billion IJ/ha to 4 billion IJ/ha.

In one embodiment, the effective amount of entomopathogenic nematode comprises between 0.5 and 7.5 billion infective nematodes (typically infective juvenile (IJ) nematodes). Across an area of land, the amount of entomopathogenic nematode preferably comprises between 2.5 and 5.0 billion infective nematodes per hectare. The effective amount of entomopathogenic nematodes will be determined by the Tipula spp. insect larvae pest situation, density, and the locus of application. Advantageously, the method of the invention provides for an application of from 50 to 75% of the effective amount.

In a preferred embodiment, the standard Tipula spp. insect larvae pest effective amount is 5.0 billion infective nematodes per hectare, so that 75% is 3.75 billion infective nematodes per hectare and 50% (or ½ rate) is 2.5 billion infective nematodes per hectare.

In another embodiment, the entomopathogenic nematodes are applied in an aqueous spray composition applied to the locus is from 500 to 1000 l/ha; in another embodiment, the water volume of the aqueous spray composition applied to the locus is 800 l/ha.

In another aspect, the present invention provides a method for controlling Tipula spp. insect larvae in turfgrass using a combination of chlorantraniliprole and entomopathogenic nematodes, comprising: a) applying chlorantraniliprole to the turfgrass at a rate of 75-300 g/ha; and b) applying entomo-pathogenic nematodes at a rate of 1 to 5 billion IJ/ha. Preferably, the chlorantraniliprole (CTPR) is applied at a rate of 100-120 g/ha and the entomopathogenic nematodes are applied at a rate of 2-3 billion IJ/ha, more preferably the CTPR is applied at 120 g/ha and the entomopathogenic nematodes are applied at 2.5 billion IJ/ha. Most preferably, the entomopathogenic nematode is Steinernema feltiae.

In one embodiment, in the method of the invention, the chlorantraniliprole and the entomopathogenic nematodes are applied simultaneously or sequentially. In a preferred embodiment, the chlorantraniliprole and the entomopathogenic nematodes are applied sequentially.

In one embodiment, when the single active ingredients are applied in a sequential manner, i.e. one after the other, it is within a reasonably short period, such as a few hours later and/or on the same day. For sequential applications, the order of applying is typically chlorantraniliprole followed by the entomopathogenic nematodes.

In a preferred embodiment, the chlorantraniliprole is applied to the locus of the Tipula spp. insect larvae pest when the larvae are in the 1st or 2nd instar stages. The nematodes are applied simultaneously or sequentially as described herein.

In another embodiment, the chlorantraniliprole is applied to the locus of the Tipula spp. insect larvae pest at cranefly peak flight (i.e., when most of the adult emergence is done). Adult Tipula spp. flights typically last for roughly four weeks in most areas with peak adult flights two weeks after the first adults are observed. The nematodes are applied simultaneously or sequentially as described herein.

In one embodiment, the chlorantraniliprole is applied at peak flight of the adult Tipula spp. (e.g., crane fly) and the entomopathogenic nematodes are applied 2 to 6 weeks after peak flight (or 2 to 6 weeks after after application of the chlorantraniliprole to the locus).

In one preferred embodiment, the entomopathogenic nematodes are applied 2 to 3 weeks after peak flight (or 2 to 6 weeks after application of the chlorantraniliprole to the locus).

In another preferred embodiment, the entomopathogenic nematodes are applied 5 to 6 weeks after peak flight (or 2 to 6 weeks after application of the chlorantraniliprole to the locus).

In a further embodiment, the chlorantraniliprole is applied 4 weeks after at peak flight of the adult Tipula spp. (e.g., crane fly) and the entomopathogenic nematodes are applied simultaneously or by a sequential application on the same day.

In a preferred embodiment, the chlorantraniliprole is applied 2-4 weeks post-peak flight simultaneously or with the nematode application or the nematode application is made sequentially within one week of the chlorantraniliprole application.

In one embodiment, the quality of the turf grass is protected, improved, maintained, or enhanced by the sequential application of chlorantraniliprole and entomopathogenic nematodes to a turf locus of Tipula spp. insect larvae pest in accordance with the method of the invention.

In one embodiment, the term “locus” means the area in which the Tipula spp. insect larvae pest eggs are found, or the 1^{st}, 2^{nd}, 3^{rd} or 4^{th} instar larvae (preferably 1st or 2nd instar) are growing, or are established, or the adult emergence of craneflies are seen (incl. peak flight). Thus, in the context of the invention, the locus will typically be an infested turf area such as golf course greens, tees and fairways, horse race courses and gallops, polo fields and airfields as well as other amenity turf areas and the like.

The aqueous spray composition of chlorantraniliprole used in the method of the invention can be prepared on site by the end-user shortly before application to the locus by mixing a chlorantraniliprole containing composition with water and, optionally, a suitable surfactant or adjuvant. Such compositions are typically referred to as “tank-mix” compositions. Suitable tank mix compositions can be prepared from mixing commercially available compositions of the active components. Examples of suitable commercial formulations of chlorantraniliprole include: Acelepryn® (an suspension concentrate (SC) formulation of chlorantraniliprole).

Similarly, the aqueous spray composition of entomopathogenic nematodes used in the method of the invention can be prepared on site by the end-user shortly before application to the locus by mixing a entomopathogenic nematodes containing composition with water and, optionally, a suitable surfactant, adjuvant or wetting agent. Suitable tank mix compositions can be prepared from mixing commercially available compositions of the active components. Examples of suitable commercial formulations of entomopathogenic nematodes include: the Nematrident® line of entomopathogenic nematodes.

Likewise, for simultaneous applications of the chlorantraniliprole with entomopathogenic nematodes, the aqueous spray composition used in the method of the invention can be prepared on site by the end-user shortly before application to the locus by mixing a chlorantraniliprole containing composition and an entomopathogenic nematode containing composition with water and, optionally, a suitable surfactant, adjuvant or wetting agent. Suitable tank mix compositions can be prepared from mixing commercially available compositions of the active components as noted above.

Accordingly, the present invention also provides a composition comprising a Tipula spp insecticidally effective amount of chlorantraniliprole, entomopathogenic nematode and, optionally, an auxiliary, diluent, adjuvant or wetting agent. Preferably, the entomopathogenic nematode in the composition is selected from Heterorhabditis bacteriophora, Heterorhabditis downesi, Steinernema feltiae, Steinernema carpocapsae, and/or Steinernema kraussei. More preferably, the entomopathogenic nematode in the composition is selected from Steinernema feltiae and Steinernema carpocapsae.

A method of combating and controlling insects, acarines, nematodes or molluscs which comprises applying to a pest, to a locus of a pest, or to a plant susceptible to attack by a pest an insecticidally, acaricidally, nematicidally or molluscicidally effective amount of a compound of formula (I), or an agrochemically acceptable salt, stereoisomer, enantiomer, tautomer or N-oxide thereof, as defined in any of claims 1-18 or a composition as defined claim 19.

In one embodiment, a soil wetting agent optionally can be applied in the practice of the method prior or during application of the entomopathogenic nematodes. Various soil wetting agents are known can reduce water repellence within a soil to which entomopathogenic nematodes are applied. For example, those which contain polyhydroxyethyl alkoxy alkylene oxides a glycol ether solvent and a polyoxyalkylene glycol surfactant. Among the suitable commercial formulations of soil wetting agents include: Qualibra®, Revolution®, and Nemaspreader®. In one embodiment, a wetting agent is applied at a rate of from 10 to 20 l/ha, preferably 10 l/ha in 400 up to 1000 litres water/ha. Preferably, the wetting agent is applied simultaneously or prior to the application of the entomopathogenic nematodes.

Controlling means killing, damaging, inhibiting the growth or significantly reducing population numbers of Tipula spp. insect larvae pests (leatherjackets) and/or the resultant craneflies at a locus, in particular a turf grass locus.

Various aspects and embodiments of the present invention will now be illustrated in more detail by way of example. It will be appreciated that modification of detail may be made without departing from the scope of the invention.

### EXAMPLES

### Example 1

In example 1, the effects of application of Acelepryn® and entomopathogenic nematodes (at 2 different rates) when used alone and in sequential combination is assessed at 2 different timings. Acelepryn® (a commercially available SC formulation of chlorantraniliprole) was applied at crane fly peak flight, and the application of entomopathogenic nematodes (Steinernema feltiae) was applied 3 weeks later. In a second treatment example, Acelepryn® was applied at crane fly peak flight followed by a nematode application 6 weeks after peak flight on turf managed as a golf green.

Applying Acelepryn® in combination with the entomopathogenic nematode Steinernema feltiae (T3 & T6) has a beneficial effect by significantly reducing population numbers of leatherjackets.

TABLE 1
Treatment list

| Treatment | Application timing | Water rate |
|---|---|---|
| [1] Untreated control | — | — |
| [2] Acelepryn (0.6 l/ha) | At peak flight | 800 (l/ha) |
| [3] Acelepryn (0.6 l/ha)+ | At peak flight+ | 800 (l/ha) |
| Half rate Nematodes (2.5) | 2-3 weeks after peak flight | 800 (l/ha) |
| [4] Half rate Nematodes (2.5) | 2-3 weeks after peak flight | 800 (l/ha) |
| [5] Full rate Nematodes (5) | 2-3 weeks after peak flight | 800 (l/ha) |
| [6] Acelepryn (0.6 l/ha)+ | At peak flight | 800 (l/ha) |
| Half rate Nematodes (2.5) | 5-6 weeks after peak flight | 800 (l/ha) |

All treatments were applied with a knapsack sprayer.

Prior to nematode application appropriate plots were spiked to allow product to penetrate the surface. After application turf was irrigated with 2-4 mm water when necessary, or a rain event occurred.

### Turf Quality

Turf was assessed visually for quality on a 1-10 scale, where 1=poor turf and 10=best quality turf (SOP RS0013). Assessments were carried out prior to treatment application and then at every assessment date during the trial.

TABLE 2
Turf quality (1-10 scale) of treated and untreated plots (DAT = days after treatment)

| | | 21 | 42 DAT [2] | 76 DAT [2] | 174 DAT [2] |
|---|---|---|---|---|---|
| | 0 | DAT | 21 DAT [3], | 55 DAT [3], [4], [5] | 153 DAT [3], [4], [5] |
| Treatment | DAT | [2] | [4], [5] | 34 DAT [6] | 132 DAT [6] |
| [1] Untreated | 6.0 | 6.1 | 6.6 | 5.9 a | 4.4 a |
| control | | | | | |
| [2] Acelepryn (0.6 | 6.0 | 6.0 | 6.8 | 6.4 ab | 5.3 b |
| l/ha) | | | | | |
| [3] Acelepryn (0.6 | 6.0 | 6.0 | 6.9 | 6.1 abc | 5.4 b |
| l/ha) + Nematodes | | | | | |
| (2.5 billion lJ/ha) | | | | | |
| [4] Nematodes | 6.0 | 6.0 | 6.3 | 6.3 bcd | 4.4 a |
| (2.5 billion lJ/ha) | | | | | |
| [5] Nematodes (5 | 6.0 | 6.0 | 6.6 | 6.0 cd | 4.5 a |
| billion lJ/ha) | | | | | |
| [6] Acelepryn (0.6 | 6.0 | 6.0 | 7.0 | 6.5 d | 5.8 b |
| l/ha) + Nematodes | | | | | |
| (2.5 billion lJ/ha) | | | | | |
| P | * | NS | NS | 0.009 | 0.002 |
| LSD | * | — | — | 0.33 | 0.70 |
| d.f. | 15 | 15 | 15 | 15 | 15 |
| % c.v. | * | 1.7 | 3.4 | 3.5 | 9.5 |

* Insufficient variation for statistical analysis
NS not statistically significant

### Leatherjacket Count

Significant differences in number of leatherjackets amongst treatments were observed on both assessment dates in this trial (Table 3). Plots treated with Acelepryn and entomopathogenic nematodes in combination (T3 & T6) has significantly fewer leather jackets than all other treatments on both assessment dates.

TABLE 3
Leather jacket count (Grubs per plot) of treated
and untreated plots (DAT = days after treatment)

| | 76 DAT [2] | 174 DAT [2] |
|---|---|---|
| | 55 DAT [3], [4], [5] | 153 DAT [3], [4], [5] |
| Treatment | 34 DAT [6] | 132 DAT [6] |
| [1] Untreated control | 17.3 bc | 26.0 cd |
| [2] Acelepryn (0.6 l/ha) | 13.3 bc | 22.2 bc |
| [3] Acelepryn (0.6 l/ha) + Half rate | 5.5 a | 13.8 a |
| Nematodes (2.5) | | |
| [4] Half rate Nematodes (2.5) | 20.8 c | 28.8 cd |
| [5] Full rate Nematodes (5) | 13.3 bc | 30.5 d |
| [6] Acelepryn (0.6 l/ha) + Half rate | 5.8 a | 16.2 ab |
| Nematodes (2.5) | | |
| P | 0.002 | 0.002 |
| LSD | 7.022 | 8.06 |
| d.f. | 15 | 15 |
| % c.v. | 36.9 | 23.3 |

In conclusion, the present invention provides and an integrated pest management method and composition for controlling Tipula spp. larvae including leatherjackets in turfgrass by applying chlorantraniliprole in combination with entomopathogenic nematodes.

1. A method for controlling a Tipula spp. insect larvae pest at a turfgrass locus using a combination of chlorantraniliprole and entomopathogenic nematodes, comprising: a) applying chlorantraniliprole to a turfgrass locus at a rate of 75-300 g/ha; and b) applying entomopathogenic nematodes to the locus at a rate of 1 to 5 billion IJ/ha.

2. The method according to claim 1, which comprises sequentially applying 75-300 g/ha of chlorantraniliprole to the locus, followed by an application of from 1 to 5 billion IJ/ha of entomopathogenic nematodes to said locus.

3. The method according to claim 1, wherein the chlorantraniliprole is applied to the locus at a rate of 100-300 g/ha; preferably at a rate of 120 g/ha.

4. The method according to claim 1, wherein chlorantraniliprole is applied to said locus in an aqueous spray composition comprising 500-1000 l/ha water; preferably 800l/ha water.

5. The method according to claim 1, wherein the Tipula spp. insect larvae pest is Tipula paludosa & Tipula oleracea; preferably in the 1st or 2nd instar stages.

6. The method according to claim 1, wherein the entomopathogenic nematode is selected from the Heterorhabditis genera and/or the Steinernema genera.

7. The method according to claim 1, wherein the entomopathogenic nematode is selected from the group: Heterorhabditis bacteriophora, Heterorhabditis downesi, Steinernema feltiae, Steinernema carpocapsae, and/or Steinernema kraussei.

8. The method according to claim 7, wherein the entomopathogenic nematode is Steinernema feltiae.

9. The method according to claim 1, wherein the entomopathogenic nematode is applied at a rate of 3.75 billion infective nematodes per hectare; preferably 2.5 billion infective nematodes per hectare.

10. The method according to claim 1, wherein the entomopathogenic nematodes are applied in an aqueous spray composition applied to the locus is from 500 to 1000 l/ha.

11. The method according to claim 1, further comprising applying a wetting agent in conjunction with the entomopathogenic nematodes.

12. The method according to claim 1, wherein the chlorantraniliprole is applied at peak flight of the adult Tipula spp. and the entomopathogenic nematodes are applied 2 to 6 weeks after peak flight or 2 to 6 weeks after application of the chlorantraniliprole to the locus.

13. The method according to claim 1, wherein the chlorantraniliprole is applied at peak flight of the adult Tipula spp. and the entomopathogenic nematodes are applied 2 to 6 weeks after peak flight or 2 to 6 weeks after application of the chlorantraniliprole to the locus.

14. The method according to claim 1, wherein the chlorantraniliprole is applied at peak flight of the adult Tipula spp. and the entomopathogenic nematodes are applied 2 to 3 weeks after peak flight or 2 to 3 weeks after application of the chlorantraniliprole to the locus.

15. The method according to claim 1, wherein the chlorantraniliprole is applied at peak flight of the adult Tipula spp. and the entomopathogenic nematodes are applied 5 to 6 weeks after peak flight or 5 to 6 weeks after application of the chlorantraniliprole to the locus.

16. The method according to claim 1, wherein the chlorantraniliprole is applied 2-4 weeks post-peak flight simultaneously or sequentially within one week of the entomopathogenic nematodes.

17. A composition comprising a Tipula spp insecticidally effective amount of chlorantraniliprole, an effective amount of an entomopathogenic nematode and, optionally, an auxiliary, diluent, adjuvant or wetting agent.
